(19) United States
(12) Patent Application Publication
(10) Pub. No.: US 2017/0148256 A1
(43) Pub. Date: May 25, 2017

(54) PHYSICS ENGINE CONFIGURATION FOR AN ELECTRONIC GAME OF CHANCE

(71) Applicant: Casino Game Maker, Inc., Las Vegas, NV (US)

(72) Inventors: Andrzej Surmacz, Las Vegas, NV (US); Darin T. Gifford, Cedar City, UT (US); Cason J. Adams, Cedar City, UT (US); Zhi Li, Cedar City, UT (US)

(73) Assignee: Casino Game Maker, Inc., Las Vegas, NV (US)

(21) Appl. No.: 14/949,817

(22) Filed: Nov. 23, 2015

(51) Int. Cl. G07F 17/32

(52) U.S. Cl. CPC G07F 17/3225; G07F 17/3211; G07F 17/3295; G07F 17/3209

(57) ABSTRACT

An apparatus is provided. The apparatus includes a data storage device that stores a graphics library, a physics engine, and a random number generator. Further, the apparatus includes a processor that operates an electronic game of chance by generating a plurality of 3D electronic game objects with the graphics library, simulating a plurality of physical properties of a physical game of chance corresponding to the electronic game of chance according to a set of physics based rules for the plurality of 3D electronic game objects, randomly determines, with the random number generator, one or more parameters of the plurality of 3D electronic game objects from a predetermined set of possible parameter results, applies the one or more parameters to the simulation, and determines an outcome of the electronic game of chance based on the plurality of physical properties.

### BACKGROUND

1. Field

This disclosure generally relates to the field of gaming. More particularly, the disclosure relates to gaming devices utilized to operate games of chance.

2. General Background

Casinos typically provide various games of chance for which an outcome is determined by a random event. Yet, live dealer versions of such games may partially include a skill aspect of the live dealer that reduces the randomness of the game of chance. As an example, a live dealer version of roulette involves a live dealer that spins a roulette wheel and releases a roulette ball on to the spinning roulette wheel. Live dealers may be capable of timing the spin of the roulette wheel and the release of the roulette ball such that the roulette ball lands in a particular region of the roulette wheel. As a result, a live dealer may be capable of reducing the quantity of numbers on which the roulette ball lands during a roulette game. Thus, live dealer roulette provides excitement for players that want to play a game of chance that may be influenced by the skill level of a particular dealer.

In contrast to a live dealer version of a game of chance, a random number generator (“RNG”) is typically utilized for electronic games of chance to generate the random event on which the outcome of the game is based. As an example, roulette is a game of chance that may be machine operated for an electronic game of chance. An RNG randomly determines the roulette outcome, i.e., the numbered pocket at which a ball lands. For instance, the RNG selects a number from one to thirty eight to determine the outcome of the roulette game. The machine operated roulette device then displays a spin of a roulette wheel and a release of a roulette ball on the roulette wheel such that the roulette ball lands on the randomly determined spot of the roulette wheel.

The electronic games of chance are often perceived by players as lacking the excitement of the live dealer versions of the games of chance as the electronic games have outcomes that are randomly determined without any perception that skill is involved. As a result, casinos often have to provide labor intensive games of chance in addition to machine based games of chance. The live dealer games of chance also involve additional costs for maintaining and cleaning physical devices, e.g., a physical roulette wheel, utilized by a live dealer.

### SUMMARY

In one aspect of the disclosure, an apparatus is provided. The apparatus includes a data storage device that stores a graphics library, a physics engine, and a random number generator. Further, the apparatus includes a processor that operates an electronic game of chance by generating a plurality of 3D electronic game objects with the graphics library, simulating a plurality of physical properties of a physical game of chance corresponding to the electronic game of chance according to a set of physics based rules for the plurality of 3D electronic game objects, randomly determines, with the random number generator, one or more parameters of the plurality of 3D electronic game objects from a predetermined set of possible parameter results, applies the one or more parameters to the simulation, and determines an outcome of the electronic game of chance based on the plurality of physical properties.

In another aspect of the disclosure, a computer program product is also provided. The computer program product includes a non-transitory computer useable storage device that has a computer readable program. The computer readable program when executed on a computer causes the computer to store, at a data storage device, a graphics library, a physics engine, and a random number generator. Further, the computer readable program when executed on the computer causes the computer to operate, with a processor, an electronic game of chance by generating a plurality of 3D electronic game objects with the graphics library, simulating a plurality of physical properties of a physical game of chance corresponding to the electronic game of chance according to a set of physics based rules for the plurality of 3D electronic game objects, randomly determines, with the random number generator, one or more parameters of the plurality of 3D electronic game objects from a predetermined set of possible parameter results, applies the one or more parameters to the simulation, and determines an outcome of the electronic game of chance based on the plurality of physical properties.

In another aspect of the disclosure, a process is provided. The process stores, at a data storage device, a graphics library, a physics engine, and a random number generator. Further, the process operates, with a processor, an electronic game of chance by generating a plurality of 3D electronic game objects with the graphics library, simulating a plurality of physical properties of a physical game of chance corresponding to the electronic game of chance according to a set of physics based rules for the plurality of 3D electronic game objects, randomly determines, with the random number generator, one or more parameters of the plurality of 3D electronic game objects from a predetermined set of possible parameter results, applies the one or more parameters to the simulation, and determines an outcome of the electronic game of chance based on the plurality of physical properties.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a physics engine configuration.

FIG. 2 illustrates the internal components of the game server illustrated in FIG. 1.

FIG. 3 illustrates a process that is utilized by the game server to utilize the physics engine in conjunction with the graphics library illustrated in FIG. 1 to generate a 3D game environment that operates according to certain physics based rules.

FIG. 4 illustrates an example of the game terminal being utilized to display an electronic roulette game generated by the game server with the physics engine, the graphics library, and the RNG illustrated in FIG. 1.

FIG. 5 illustrates a process that is utilized by the game server illustrated in FIG. 1 to provide an electronic game of chance.

FIG. 6 illustrates an example of a physics world.

### DETAILED DESCRIPTION

A physics engine configuration for a game of chance is provided to allow a player to perceive a skill aspect during operation of the game of chance. The physics engine configuration provides an electronic game of chance that may be played by a player at an electronic gaming terminal. The physics engine configuration removes a need for an RNG to determine the outcome as utilized by current configurations. In contrast, the physics engine configuration utilizes an RNG only to determine certain skill based parameters such as a release of a ball, dice, etc. and an amount of time at which that object is deemed to be active, e.g., rolling. The outcome of the game of chance is then determined by certain physics based rules that are pertinent to the game structure that is displayed by the electronic gaming terminal, e.g., a roulette wheel that operates in the virtual world of the electronic game according to certain real world physics based rules. As a result, the physics engine configuration allows for a game of chance to be played that provides the player with the perception of being the live dealer and having a skill that can influence the game of chance even though that skill is only a perception.

The physics engine configuration improves the functioning of a computer as previous configurations had to utilize an RNG entirely to determine an outcome. As a result, previous configurations posed a technology problem of utilizing a machine that did not have any technology that provided the appearance of involving any skill of the player. The physics engine configuration provides a technology based solution that improves the functioning of gaming terminals by utilizing specialized computing technology to generate a game of chance that provides the player with a perception that a game of chance is partially skill based.

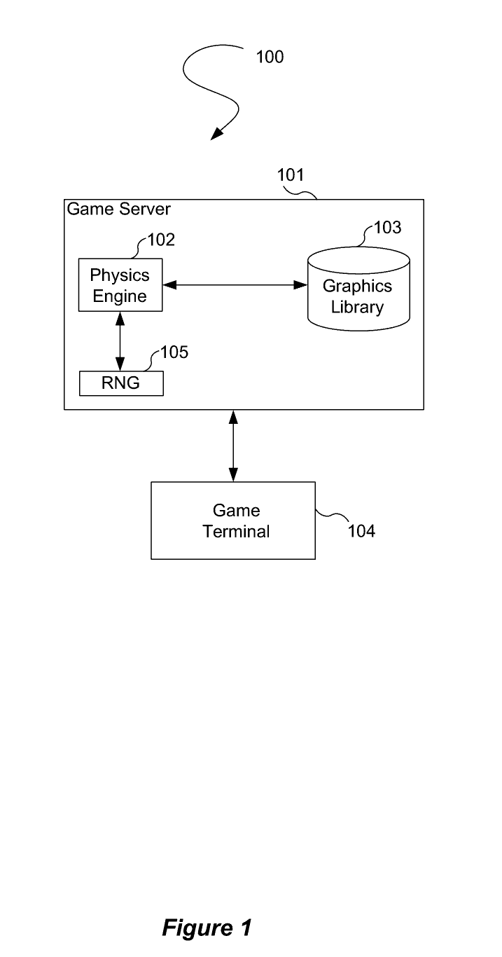

FIG. 1 illustrates a physics engine configuration 100. The physics engine configuration 100 includes a game server 101 and a game terminal 104. The game server 101 performs the game functionality to determine the outcome of a game of chance. The game server 101 also determines certain game parameters that are provided to the game terminal 104 so that the game terminal 104 may display the game of chance according to those game parameters. Communication is established between the game server 101 and the game terminal 104 so that the game terminal may render play of the game of chance.

The game server 101 includes a physics engine 102, a graphics library 103, and an RNG 105. The physics engine 102 and the graphics library 103 generate an environment for displaying the game of chance according to physics based rules.

The graphics library 103 is utilized by the game server 101 to build a virtual world for the game environment that can be rendered in 3D by the game terminal 104. As a display device that is integrated into the game terminal 104 or in operable communication with the game terminal 104 is typically only capable of displaying 2D images, the graphics library 103 projects a 3D model on a 2D plane of objects in the game environment. For instance, the graphics library 103 performs transformations on the objects of the game environment from 3D to 2D by determining what a 2D image of each object in the game environment would appear to be if a viewer views that object from a certain perspective. Although perspective projection may lead to objects at a distance appearing smaller than objects that are close and closer objects hiding farther objects, the graphics library 103 is utilized by the game server 101 to add each object to a virtual environment even if some of the objects are hidden by other objects. The objects in the virtual game environment are permitted to be moved in a manner that maintains a 3D perspective, but without any restriction based upon real world rules.

The physics engine 102 is utilized by the game server 101 to provide an approximate simulation of a physical game environment. In other words, the physics engine 102 generates a virtual game simulation of a physical world game environment based upon certain physics based rules of the physical world game environment. Therefore, objects in the virtual game simulation will have properties and behaviors based upon the physical world game environment that is being simulated. The physics engine 102 may store the state of each of the objects in the game environment based upon that object's simulated real world properties and behaviors. Further, the physics engine 102 may update the state of each of the objects during each action of the simulation according to the physics based rules. As a result, objects in the game environment react to changes of state of other objects in a realistic manner.

The game server 101 utilizes the graphics library 103 in conjunction with the physics engine 102 to associate the objects of the 3D virtual world generated with the graphics library 103 and the physical properties and behaviors of those corresponding objects determined by the physics engine 102. The objects generated by the physics engine 102 are described by properties such as mass, velocity, collision shape, etc. The object properties may change based upon reactions to other objects in the game environment. The collision shape is not a visible property. The association of the 3D virtual world generated with the graphics library 103 and the physics engine 102 allows for the collision or other properties to have a visual shape that is referred to as a skin. The association between the virtual world generated with the graphics library 103 and the simulation generated with the physics engine 102 is determined by an assignment of a skin from the 3D virtual world to each object in the simulation generated by the physics engine 102. As a result, the game server 101 generates a 3D game environment for an electronic game that observes real world properties and behaviors.

Further, the game server 101 utilizes the RNG 105 to determine certain game parameters that are utilized by the physics engine 102 to determine an outcome of the game of chance according to physics based rules. In contrast with previous configurations that utilize an RNG to determine an outcome of a game of chance, e.g., a via a random selection of a number from one to thirty eight corresponding to number roulette pockets, the game server 101 utilizes the RNG 105 to determine the parameters that are inputted to the physics engine 102 so that the physics engine determines an outcome of the physics based rules as applied to those parameters. For instance, the game parameters may be physical world parameters that are perceived by a player as being skill based, e.g., a dealer spin or a roulette wheel and a dealer release of a ball on the spinning roulette wheel. The physics engine 102 then applies physics based rules, e.g., velocity of the ball, to such parameters to determine the outcome of the game of chance.

In various embodiments, the parameters for which the RNG 105 is utilized have predetermined possible results. For example, the RNG 105 may randomly generate a time for releasing a ball on a roulette wheel by randomly selecting from ten different predetermined time spans. As another example, the RNG 105 may randomly generate a velocity for a spin of a roulette wheel by randomly selecting from ten different predetermined velocities.

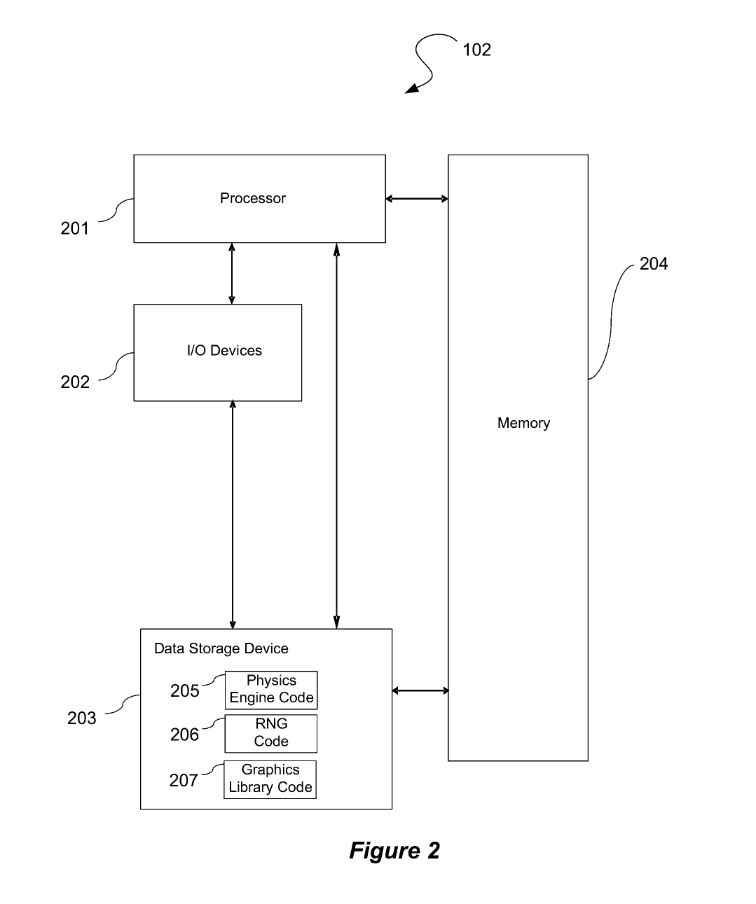

FIG. 2 illustrates the internal components of the game server 101 illustrated in FIG. 1. The game server 102 includes a processor 201, input/output (“I/O”) devices 202, a data storage device 203, and a memory 204. The data storage device 203 may store physics engine code 205 for implementing the physics engine 102, RNG code 206 for implementing the RNG 105, and graphics library code 207 for implementing the graphics library 103.

Further, the processor 201 may be specialized. For instance, the processor 201 may be specifically configured to associate the physics engine 102 and the graphics library 103. Therefore, the processor 201 improves the functioning of a computer by applying the physics based rules generated by the real world simulation from the physics engine 102 to the virtual world generated by the graphics library 103.

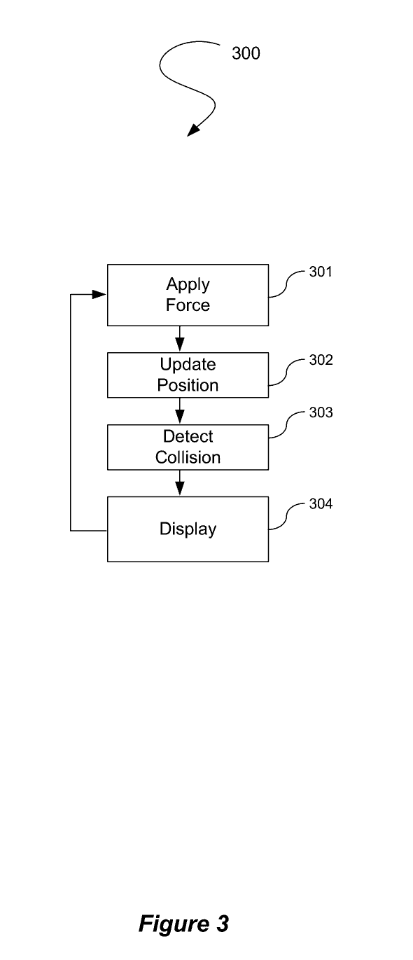

FIG. 3 illustrates a process 300 that is utilized by the game server 101 to utilize the physics engine 102 in conjunction with the graphics library 103 illustrated in FIG. 1 to generate a 3D game environment that operates according to certain physics based rules. At a process block 301, the process 300 utilizes the physics engine 102 to apply a force to an object in the real world simulation of the game environment. In other words, the physics engine 102 is utilized to apply a force to each object during each action of the real world simulation. The physics engine 102 may perform certain calculations as a result of the application of the force. For instance, the physics engine 102 may calculate velocity, acceleration, and/or other physics based properties.

Further, at a process block 302, the process 300 utilizes the physics engine 102 to then update the position of each object in the real world simulation based upon the reaction of each object to the application of force generated at the process block 301. Some objects may have moved whereas other objects may remain stationary as a result of the application of force generated at the process block 301.

In addition, at a process block 303, the process 300 utilizes the physics engine 102 to detect any collisions of the objects in the real world simulation that result from changes of state of the objects. The collision detection is performed based upon the position of the objects and the collision shape of the objects. If two objects collide, the physics engine 102 gives an opposite impulse to each object.

At a process block 304, the process 304 then transitions to utilizing the graphics library 103 to display a 3D virtual environment of the objects based upon the state of each object as determined by the physics rules determined by the physics engine 102. The process 300 then advances to the process block 301 to perform the process 300 for another action in the physical world simulation. Each simulation action may be performed in multiple instances per second so that a player of the game of chance may view a continuous simulation of the physical world environment.

The physics engine configuration 100 illustrated in FIG. 1 may be utilized for a variety of games of chance in which a physical game environment may be simulated for a virtual game environment, e.g., roulette, games based on rolling dice, etc. Roulette is discussed as an example of such a game of chance, but other types of games of chance may be utilized by the physics engine configuration 100.

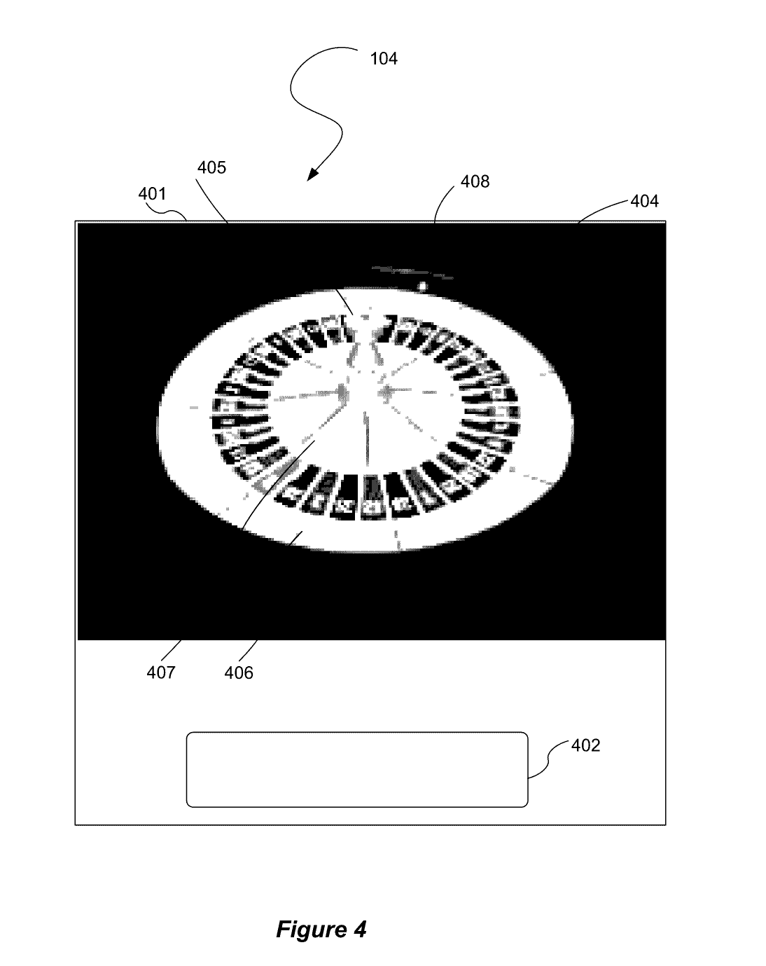

FIG. 4 illustrates an example of the game terminal 104 being utilized to display an electronic roulette game generated by the game server 101 with the physics engine 102, the graphics library 103, and the RNG 105 illustrated in FIG. 1. The game terminal 104 has an integrated display device 401, which may alternatively be a distinct display device that is in operable communication with the game terminal 104. Further, the game terminal 104 has a game input device 402. The game input device 402 may include a touch screen, a plurality of buttons, etc. that allows the user to provide inputs, e.g., game selection, wager, etc. to the game terminal 401.

The display device 401 displays an electronic roulette game environment 403. The electronic roulette game environment 403 includes a roulette wheel 407 that is spun during play of the roulette game. Further, the electronic roulette game environment 403 has a ball 408 that is released on to the spinning roulette wheel 407 during play of the roulette game. The electronic roulette game environment 403 also has a rim 404, a turret 405, and one or more deflectors 406.

Each of the objects 404-408 is a virtual representation of a corresponding real world object that has physical real world properties and behaviors. The physics engine 102 determines the physical real world properties and behaviors of each object for simulation in the electronic roulette game environment 403.

Each of the objects in a particular game of chance may have certain properties and behaviors particular to the game environment for that game of chance. For example, the electronic roulette game environment 403 may include fixed objects such as the rim 404 and the one or more deflectors 406. The fixed aspect is a physical property that is simulated by the electronic roulette game environment 403. Further, the roulette wheel 407 and the turret 405 may spin at a constant angular velocity. The objects 404-407 may collide with and add force to the ball 408, but will not be moved by a reaction force. Such properties and behaviors simulate the real physical world counterparts of the objects 404-407.

As an example, a user may provide an input via the game input device 402 at the game terminal 104 that the user wants to begin playing an electronic game of roulette. The game terminal 104 requests game data from the game server 101 for the electronic game of roulette. The game server 101 provides various data to the game terminal 104 so that the game terminal may render a display of an electronic roulette game according to randomly generated parameters utilized to determine an outcome according to physics rules of the electronic roulette game environment 403.

For instance, the game terminal 104 displays a spin of the roulette wheel 407 and the turret 405 at the outset of the electronic game of roulette requested by the user. The ball 408 may spin around the rim 404 several times to simulate circular motion. Such simulation of circular motion may be an approximation performed by the physics engine 102. Further, the game terminal 104 utilizes the randomly generated time of release of the ball 408 and the rolling distance of the ball 408 as determined by and received from the game server 101 to render a display of the ball 408 being released and rolling around the electronic roulette game environment 403. After the ball 408 rolls around the rim 404, the game terminal 104 displays the ball 408 moving at an initial velocity determined by the game server 101. Subsequent movement of the ball 408 is determined by the physics engine 102 and displayed by the game terminal 104. After the ball 408 diminishes in velocity, the ball 408 moves from the rim 404 to one of a plurality of pockets situated on the roulette wheel 407. The game server 101 utilizes the physics engine 102 and the graphics library 103 to determine at which graphical object, i.e., which pocket, the ball 408 completes movement with respect to the roulette wheel 407.

Therefore, the movement of the ball 408 may be at least partially controlled by the physics engine 102. The physical counterparts of the various structures of an electronic game of chance, e.g., 404-408, are utilized to determined corresponding states in the game of chance based upon reactions or lack of reactions to other structures in the electronic game of chance.

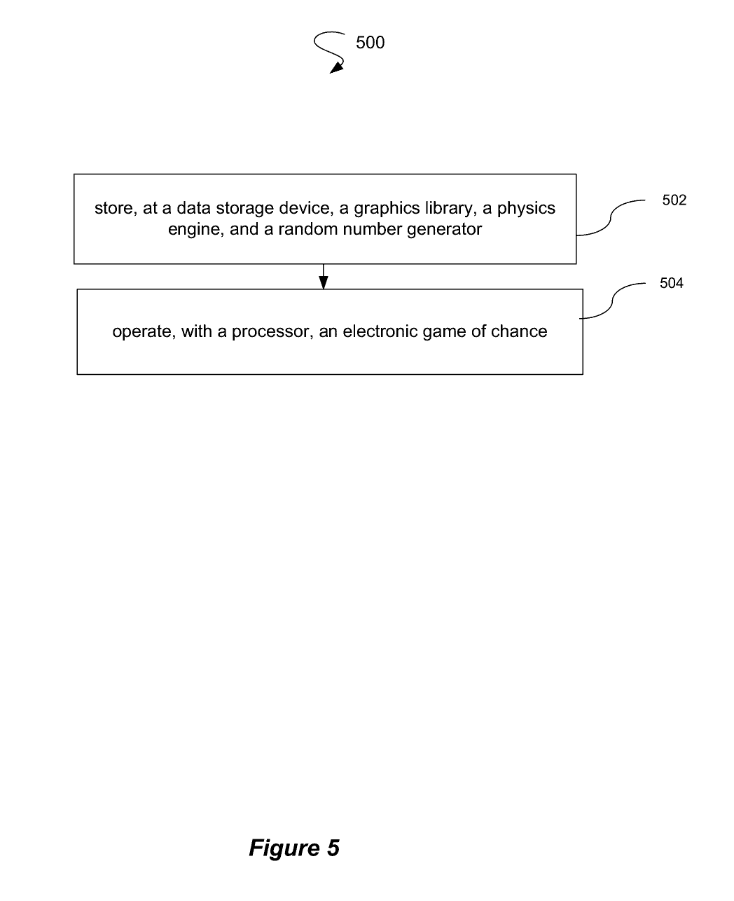

FIG. 5 illustrates a process 500 that is utilized by the game server 101 illustrated in FIG. 1 to provide an electronic game of chance. At a process block 502, the process 500 stores, at a data storage device, a graphics library, a physics engine, and a random number generator. Further, at a process block 504, the process 500 operates, with a processor, an electronic game of chance. The processor may be a specialized processor that is configured to associate the physics engine 102 with the graphics library 103 to improve the functioning of a computer. The process 500 utilizes the processor to generate a plurality of 3D electronic game objects with the graphics library, simulate a plurality of physical properties of a physical game of chance corresponding to the electronic game of chance according to a set of physics based rules for the plurality of 3D electronic game objects, randomly determine, with the random number generator, one or more parameters of the plurality of 3D electronic game objects from a predetermined set of possible parameter results, apply the one or more parameters to the simulation, and determine an outcome of the electronic game of chance based on the plurality of physical properties.

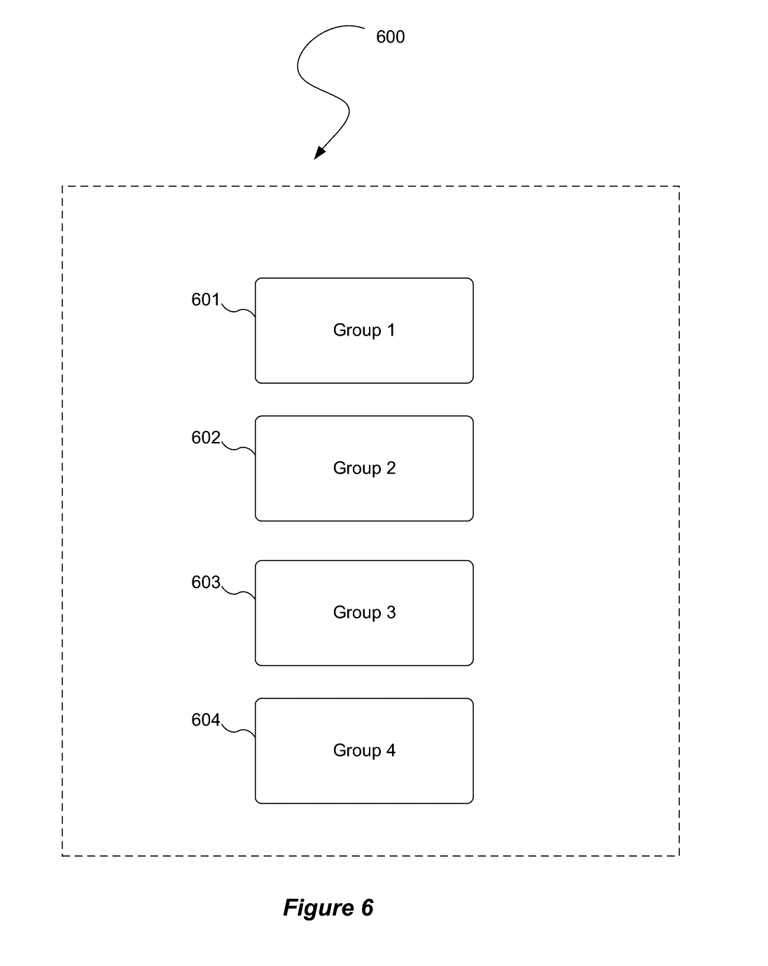

Although one electronic game of chance is illustrated in FIG. 4, the physics engine configuration 100 may be utilized to implement multiple electronic games of chance. For instance, a player may want to play multiple versions of the same game of chance, e.g., multiple roulette wheels, in parallel at the game terminal 104. In various embodiments, the physics engine 102 illustrated in FIG. 1 may be utilized to implement multiple games of chance in parallel. FIG. 6 illustrates an example of a physics world 600. The physics world 600 allows for multiple versions of an electronic game of chance to be played in parallel by grouping all of the objects from the various versions of the electronic game of chance into the same physical world 600, e.g., via a first group 601, a second group 604, a third group 603, and a third group 604. For example, four different instance of an electronic game of chance of roulette may be implemented. In other words, four different roulette wheels, four different balls, four different turrets, four different rims, and four different sets of deflectors are all stored in the physics world 600. Different groups are utilized to categorize each different instance of an electronic game of roulette such that each group only has one roulette wheel, one ball, one turret, one rim, and one set of deflectors. Therefore, the game server 101 may utilize the physics engine 102 to simulate parallel virtual worlds in one physics world 600.

It is understood that the apparatuses, processes, and systems described herein may also be applied in other types of apparatuses, processes, and systems. Those skilled in the art will appreciate that the various adaptations and modifications of the embodiments of the apparatuses, processes, and systems described herein may be configured without departing from the scope and spirit of the present apparatuses, processes, and systems. Therefore, it is to be understood that, within the scope of the appended claims, the present apparatuses, processes, and systems may be practiced other than as specifically described herein.

We claim:

1. An apparatus comprising:
a data storage device that stores a graphics library, a physics engine, and a random number generator; and
a processor that operates an electronic game of chance by generating a plurality of 3D electronic game objects with the graphics library, simulating a plurality of physical properties of a physical game of chance corresponding to the electronic game of chance according to a set of physics based rules for the plurality of 3D electronic game objects, randomly determines, with the random number generator, one or more parameters of the plurality of 3D electronic game objects from a predetermined set of possible parameter results, applies the one or more parameters to the simulation, and determines an outcome of the electronic game of chance based on the plurality of physical properties.

2. The apparatus of claim 1, further comprising a transmitter that sends the plurality of 3D electronic game objects to a game terminal so that the game terminal displays the plurality of 3D electronic game objects.

3. The apparatus of claim 1, wherein the processor further updates a state of the plurality of 3D electronic game objects based upon a modification to the plurality of physical properties.

4. The apparatus of claim 3, further comprising a transmitter that sends the update to the state of the plurality of 3D electronic game objects to a game terminal so that the game terminal displays the update.

5. The apparatus of claim 1, wherein the one or more parameters of the plurality of 3D electronic game objects correspond to features of the corresponding physical game of chance that are at least partially skill based.

6. The apparatus of claim 1, wherein the electronic game of chance is roulette.

7. The apparatus of claim 3, wherein the electronic game of chance utilizes dice.

8. A computer program product comprising a non-transitory computer useable storage device having a computer readable program, wherein the computer readable program when executed on a computer causes the computer to:
store, at a data storage device, a graphics library, a physics engine, and a random number generator; and
operate, with a processor, an electronic game of chance by generating a plurality of 3D electronic game objects with the graphics library, simulating a plurality of physical properties of a physical game of chance corresponding to the electronic game of chance according to a set of physics based rules for the plurality of 3D electronic game objects, randomly determines, with the random number generator, one or more parameters of the plurality of 3D electronic game objects from a predetermined set of possible parameter results, applies the one or more parameters to the simulation, and determines an outcome of the electronic game of chance based on the plurality of physical properties.

9. The computer program product of claim 8, wherein the computer is further caused to send the plurality of 3D electronic game objects to a game terminal so that the game terminal displays the plurality of 3D electronic game objects.

10. The computer program product of claim 8, wherein the computer is further caused to update a state of the plurality of 3D electronic game objects based upon a modification to the plurality of physical properties.

11. The computer program product of claim 10, wherein the computer is further caused to send the update to the state of the plurality of 3D electronic game objects to a game terminal so that the game terminal displays the update.

12. The computer program product of claim 8, wherein the one or more parameters of the plurality of 3D electronic game objects correspond to features of the corresponding physical game of chance that are at least partially skill based.

13. The computer program product of claim 8, wherein the electronic game of chance is roulette.

14. The computer program product of claim 13, wherein the electronic game of chance utilizes dice.

15. A method comprising:
storing, at a data storage device, a graphics library, a physics engine, and a random number generator; and
operating, with a processor, an electronic game of chance by generating a plurality of 3D electronic game objects with the graphics library, simulating a plurality of physical properties of a physical game of chance corresponding to the electronic game of chance according to a set of physics based rules for the plurality of 3D electronic game objects, randomly determines, with the random number generator, one or more parameters of the plurality of 3D electronic game objects from a predetermined set of possible parameter results, applies the one or more parameters to the simulation, and determines an outcome of the electronic game of chance based on the plurality of physical properties.

16. The method of claim 15, further comprising sending the plurality of 3D electronic game objects to a game terminal so that the game terminal displays the plurality of 3D electronic game objects.

17. The method of claim 15, further comprising updating a state of the plurality of 3D electronic game objects based upon a modification to the plurality of physical properties.

18. The method of claim 17, further comprising sending the update to the state of the plurality of 3D electronic game objects to a game terminal so that the game terminal displays the update.

19. The method of claim 15, wherein the electronic game of chance is roulette.

20. The method of claim 15, wherein the electronic game of chance utilizes dice.
